(19) United States
(12) Patent Application Publication
(10) Pub. No.: US 2025/0348478 A1
(43) Pub. Date: Nov. 13, 2025

(54) USING GENERATIVE MODELS FOR ANALYTIC TASKS

(71) Applicant: GOOGLE LLC, Mountain View, CA (US)

(72) Inventors: Alan Papir, Armonk, NY (US); Idan Heimlich Shtacher, Mountain View, CA (US); Tianren Zhang, San Jose, CA (US); Jing Chen, Santa Clara, CA (US); Samuel Sobell, New York, NY (US); Srividya Pranavi Potharaju, Union City, CA (US); Yang Song, San Mateo, CA (US); Chenmei Li, Sunnyvale, CA (US)

(21) Appl. No.: 19/204,433

(22) Filed: May 9, 2025

Related U.S. Application Data
(60) Provisional application No. 63/645,945, filed on May 12, 2024.

(51) Int. Cl. G06F 16/242; G06F 8/41; G06F 8/71; G06F 16/248

(52) U.S. Cl. CPC G06F 16/242; G06F 8/43; G06F 8/71; G06F 16/248

(57) ABSTRACT

Implementations are provided for facilitating multi-turn dialogs with a generative model-based agent (GMAgent) that allow for multi-step analysis of external data source(s), including refinement of that analysis. In various implementations, data indicative of a first query and external data source(s) may be assembled into a first prompt. The first prompt may be processed using generative model(s) to generate first output data that includes first source code that is executable to perform an analytic task on data from the external data source(s). The first source code may be executed to perform the analytic task using the external data source(s) and generate analytic output. The analytic output may be assembled into a second prompt with a command to determine whether the analytic output satisfies the first query. The second prompt may be processed using generative model(s) to generate second output data that indicates whether the analytic output satisfies the first query.

### BACKGROUND

Generative models such as large language models (LLMs) and vision language models (VLMs) are useful for predicting output sequences of tokens that represent various types of data (e.g., text, images, audio) based on input sequences of tokens. However, generative models sometimes struggle with logical tasks such as answering mathematical questions or performing analytic tasks on data.

### SUMMARY

Implementations described herein relate to using generative models such as LLMs and/or VLMs to predict tokens representing executable state machines, e.g., in the form of source code such as high-level programming languages, scripting language, etc., so that those state machines can be executed to generate output that is responsive to a user query. More particularly, but not exclusively, techniques described herein relate to facilitating multi-turn dialogs with a generative model-based agent (GMAgent) that allow for multi-step analysis of user-uploaded files and/or documents, including refinement of that analysis, as well as generation of new files (including rich/interactive visualizations) by the GMAgent.

“External data sources” may include any data source that is external to the generative model(s) being applied. The external data sources may not necessarily be publicly available, or may be so new as to have not yet been used to train the generative model(s), although this is not required. For example, external data sources may include private documents controlled/maintained by a user and/or an organization. In various implementations, external data sources that may be analyzed by the GMAgent may include, for instance, spreadsheets, comma-separated value (CSV) data, tab-separated value (TSV) data, database tables, database views, word processing documents, slides, electronic correspondence (e.g., email, text messages), portable document format (PDF) files, structured documents such as documents written in the extensible markup language (XML), hypertext markup language (HTML), JavaScript Object Notation (JSON), etc., and any other external data source that includes data capable of being extracted, parsed and/or analyzed using a generative model.

Various techniques described herein relate to generating and evaluating analytic tasks using one or more processors. These techniques may include, for instance, assembling data, including a first query and data identifying external data source(s), into a first prompt. In some implementations, the external data source(s) may be identified in the first query. In other instances, the external data sources may be uploaded by the user contemporaneously with the user providing the query. Any number of external data sources may be identified in the prompt. In some implementations, the first prompt may include an implicit or explicit (e.g., user-provided) command to generate source code for performing one or more analytic tasks on data from the external data source(s).

The first prompt may then be processed using generative model(s) to generate source code for performing an analytic task on data from the external source(s). The source code may then be executed, e.g., in a “sandboxed” execution environment, to generate analytic output. The analytic output may then be assembled into a second prompt, e.g., along with a command to determine whether the analytic output satisfies the first query. This second prompt may then be processed using generative model(s) to determine whether the analytic output satisfies the first query. If the analytic output fails to satisfy the query, the process may repeat, e.g., by building subsequent prompt(s) that are processed using the generative model(s) to generate refined instance(s) of source code, which are executed to generate refined analytic output that is evaluated for satisfaction of the query. Once the query is satisfied, the final analytic output may be rendered at output device(s) and the process may end.

### BRIEF DESCRIPTION OF THE DRAWINGS

FIG. 1 schematically depicts an example environment in which selected aspects of the present disclosure may be implemented.

FIG. 2 schematically depicts an example of how data may be processed by and/or exchanged between various components configured with selected aspects of the present disclosure.

FIG. 3 schematically depicts an example method for practicing selected aspects of the present disclosure.

FIG. 4 schematically depicts an example method for practicing selected aspects of the present disclosure.

FIG. 5 schematically depicts an example method for practicing selected aspects of the present disclosure.

FIG. 6 schematically depicts an example computer architecture.

### DETAILED DESCRIPTION

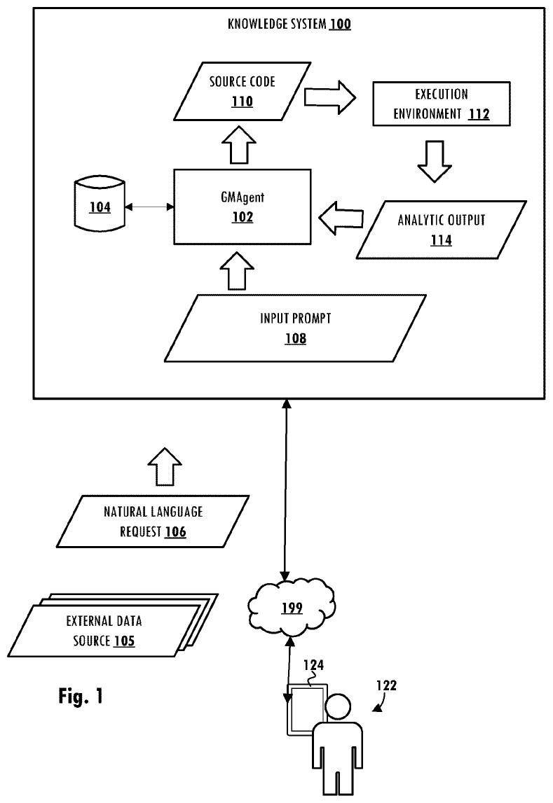

FIG. 1 is a schematic diagram illustrating components that can cooperate to carry out selected aspects of the present disclosure, in accordance with various implementations. The various components depicted in FIG. 1, particularly those components forming a knowledge system 100, may be implemented using any combination of hardware and software. The components of FIG. 1 are depicted as being communicatively coupled with each other via one or more networks 199, which may include one or more personal area networks, local area networks, and/or wide area networks (e.g., the Internet). However, this is not meant to be limiting. Various aspects of the present disclosure that are described as being performed by and/or stored on system 100 can alternatively be performed by and/or stored elsewhere and/or distributed across multiple systems, such as between system 100 and a client device 124.

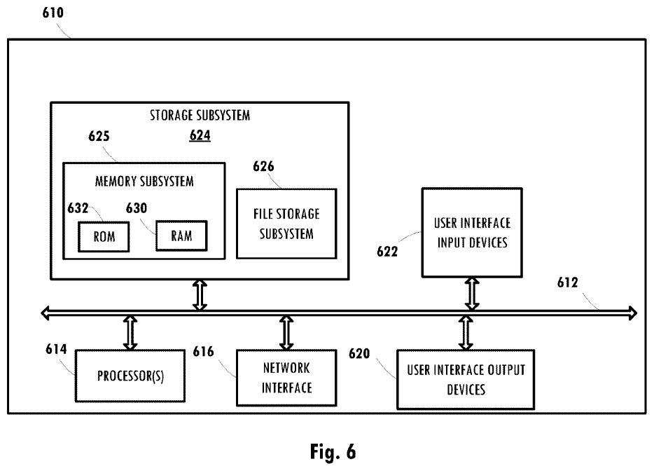

In some implementations, knowledge system 100 may include one or more computing devices cooperating to perform selected aspects of the present disclosure. An example of such a computing device is depicted schematically in FIG. 6. In some implementations, knowledge system 100 may include one or more servers forming part of what is often referred to as a “cloud” infrastructure, or simply “the cloud.” Alternatively, one or more components of system 100 may be operated by client device 124.

Knowledge system 100 may include a generative model agent (GMAgent) 102 communicatively coupled with one or more machine learning and/or generative model(s) 104. Machine learning and/or generative model(s) 104 described herein may take various forms, including, but not limited to, model(s) such as PaLM, BERT, LaMDA, Meena, and/or any other generative model, such as any other generative model that is encoder-only based, decoder-only based, sequence-to-sequence based and that optionally includes an attention mechanism, or other memory, diffusion model(s), etc. Generative models may have hundreds of millions, or even hundreds of billions of parameters. In some implementations, generative models may include multi-modal models such as a vision-language model (VLM) and/or a visual question answering (VQA) model, which can have any of the aforementioned architectures, and which can be used to process multiple modalities of data, particularly images and text, and/or images and audio for example, to generate one or more modalities of output. Non-limiting examples of VLMs that may be applied as described herein include Gemini and/or Flamingo, to name a few.

In various implementations, a user 122 may interact with knowledge system 100 using client device 124. While depicted as a tablet computer or smart phone in FIG. 1, client device 124 may take other forms, such as a desktop or laptop computer, in-vehicle computing device, augmented reality (AR) and/or virtual reality (VR) headset or glasses, standalone “smart” speakers that host automated assistants that can be interacted with, etc.

While shown as separate systems that communicate using network(s) 199, this is not meant to be limiting. Aspects of knowledge system 100 may be implemented in whole or in part on client device 124. If client device 124 includes sufficient computing resources, and/or generative model(s) it uses can be made sufficiently “lean,” it may be desirable to implement techniques described herein locally on client device 124 to avoid latency introduced by a round trip across network(s) 199.

User 122 may operate client device 124 to interact with knowledge system 100 by providing a natural language request 106 to knowledge system 100. Natural language request 106 may in some cases be a textual snippet that is typed by user 122 or spoken and transcribed using speech-to-text (STT) processing. STT processing may be implemented on client device 124 and/or knowledge system 100. In various implementations, data indicative natural language request 106 may be processed by knowledge system 100 as all or part of an input prompt 108.

In some cases, input prompt 108 may include the text of natural language request 106 by itself. In some such cases, the text of natural language request 106 may identify one or more external data source(s) 105 that contain data on which user 122 wishes to perform analytic task(s). In other cases, input prompt 108 may include additional text and/or other data such as embedding(s). This other data may include, for instance, data about a context of user 122, one or more sensor signals generated by client device 124 (e.g., position coordinates, time-of-day, gyroscope and/or accelerometer signals, etc.), copies of (or pointers to) external data sources 105 that have, for instance, been uploaded to knowledge system 100 by user 122, and so forth. While examples described herein relate to processing natural language requests in textual form, this is not intended to be limiting. In various implementations, techniques described herein may additionally or alternatively be used to process other modalities of data (e.g., images, audio streams, videos, etc.), including multiple different modalities at once.

GMAgent 102 may be configured to process any number of input prompts, e.g., beginning with input prompt 108, and/or data indicative thereof (e.g., embedding(s)) using one or more machine learning and/or generative model(s) 104 to generate various types of output. This output may include, for instance, “planner” output that indicates one or more next steps that should be performed. For example, if requested to analyze external data source(s) 105, e.g., a spreadsheet uploaded by user 122, the planner output generated by GMAgent 102 using machine learning and/or generative model(s) 104 may include command(s) (e.g., in natural language or otherwise) to generate source code 110 that is executable to perform a variety of different tasks.

Additionally, output generated by GMAgent 102 may include source code 110 itself. Source code 110 may be executable, e.g., in an execution environment 112 integral with or accessible by knowledge system 100, to perform various aspects of analytic tasks. As one example, source code 110 may be executable to extract at least some data from one or more identified external data source(s) 105. The extracted data may then be analyzed, e.g., by GMAgent 102 during a subsequent turn/iteration, to determine one or more next steps, such as identifying, and presenting to user 122 in some instances, candidate analytic task(s) that can be performed using the external data source(s) 105, given the nature of the extracted data. Given the identified candidate analytic task(s), additionally source code 110 may be generated that is executable to perform the candidate analytic task(s) on data from external data source(s) 105.

Source code 110 may be executed in execution environment 112 to generate what will be referred to herein as “analytic output” 114. Analytic output 114 may include data that GMAgent 102 is not itself adept at generating using machine learning and/or generative model(s) 104. For example, analytic output 114 generated by executing the source code 110 may include analytic/statistical insights, solutions, conclusions, inferences, deductions, data visualizations (e.g., charts, graphs, etc.), data that is operable to render interactive visualizations (e.g., JSON files that can be used as grammars to render with visualization tools, files composed in printed circuit board (PCB) file formats such as Gerber), or any other data that may be generated by executing source code 110 in execution environment 112 to perform analytic task(s) on data from external data source(s) 105.

In some implementations, analytic output 114 may be provided to GMAgent 102 to be evaluated for satisfaction of the original natural language request 106. For example, GMAgent 102 may assemble all or parts of analytic output 114 into a prompt. This prompt may also include other data indicative of, for instance, a command (explicitly provided by user 122 or implicitly added) to determine whether analytic output 114 satisfies natural language request 106, source code 110 that was executed to yield analytic output 114, data extracted from external data source(s) 105, etc. GMAgent 102 may then process this prompt using machine learning and/or generative model(s) 104 to generate additional output data that indicates whether analytic output 114 satisfies the first query. If the answer is yes, in some implementations, analytic output 114 may be provided to user device 124, e.g., so that it can be presented to user 122 as a response to natural language request 106. If the answer is no, e.g., because the additional output data explicitly indicates as much or includes a command to generate refined source code that ostensibly will better perform the analytic task(s), then the process may repeat.

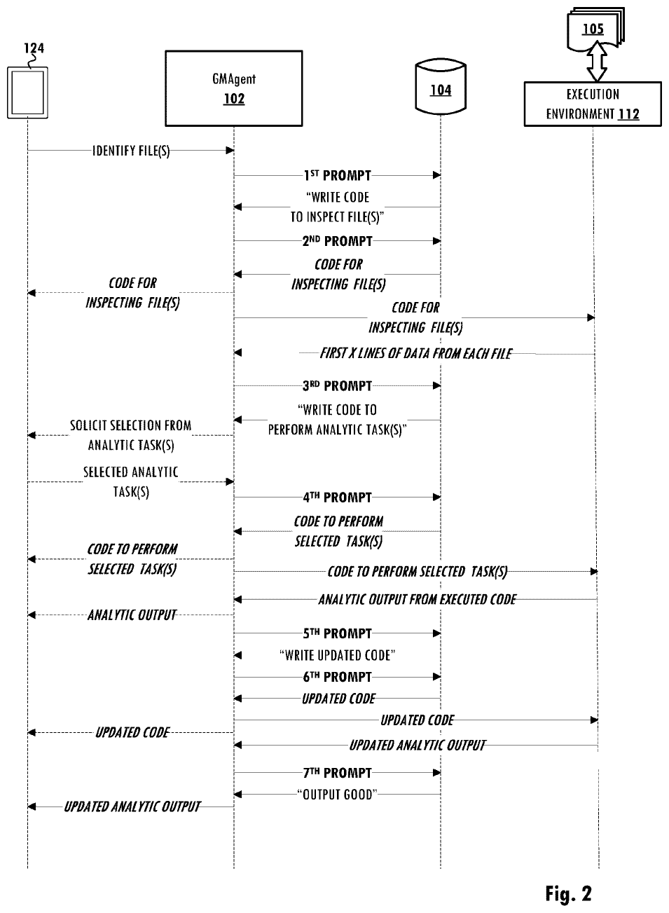

FIG. 2 schematically depicts an example of how selected aspects of the present disclosure may be carried out between various elements of FIG. 1, including client device 124, GMAgent 102, machine learning and/or generative model(s) 104, and execution environment 112. In FIG. 2, time runs down the page. Arrows leading between the various components may or may not include communications that are exchanged over network(s) 199. The exchanges of data depicted in FIG. 2 are for illustrative purposes only. Different exchanges of data than those depicted in FIG. 2 are possible.

Starting at top left, client device 124 is operated to identify one or more external data source(s) 105 (e.g., files) that are to be subjected to analytic evaluation. In some implementations, external data sources 105 may be identified in the initial query, which may or may not include a natural language request 106. For example, user 122 could utter, type, or operate a file system browser to select a path to a file and/or to input a filename, a uniform resource identifier (URI), etc. Additionally or alternatively, user 122 may type or utter natural language request, and in conjunction, upload one or more external data source(s) 105 that user 122 wishes to analyze. As a working example, assume that user 122 uploads two spreadsheets, one with high-level worldwide weather data and another with more granular weather data in the United States, and inputs (speaks or types) the natural language query, “What can you tell me about climate trends in Kentucky?”

GMAgent 102 may then assemble a first prompt that includes data indicative of the query and external data sources. In some implementations, the first prompt may also be assembled with a command to determine what to do next. GMAgent 102 may then process the first prompt using machine learning and/or generative model(s) 104 to generate output that predicts/suggests next step(s). For example, in FIG. 2, the next step that is predicted by GMAgent 102 is “Write code to inspect file(s).” In the weather spreadsheet working example, the next step may be more specific, such as “Write code to extract the first ten rows from each weather spreadsheet.” This prediction may be a result of machine learning and/or generative model(s) 104 being trained and/or fine-tuned based on various training example dialogs. In some such training example dialogs, users may have uploaded or otherwise identified spreadsheet(s) with relatively vague commands, and then explicitly requested that machine learning and/or generative model(s) 104 be used to generate/predict source code to extract some number of rows from the files.

While not shown in FIG. 2, in some implementations, GMAgent 102 may transmit some data indicative of next step(s) to client device 124 that is renderable to apprise user 122 of what is happening. For example, an ongoing transcript of a conversation between GMAgent 102 and user 122 may be updated with actions GMAgent 102 is taking and/or next steps it is predicting. As another example, in some implementations where GMAgent 102 generates source code, GMAgent 102 may execute the source code and then send both the executed source code and the analytic output it generated to user device 124 simultaneously, e.g., so that the user can see the result and how it was generated. In other implementations, GMAgent 102 may send the executed source code to user device 124 only where the analytic output appears to be misaligned with the user's quer (ies).

In some implementations, the machine learning and/or generative model(s) 104 may be trained to predict which of the multiple external data source(s) 105 are most likely going to be useable to generate a response to a user's query. In the weather spreadsheet working example, for instance, the next step generated by GMAgent 102 based on the first prompt could be more specific, such as “Write code to extract the first ten rows from the Kentucky weather spreadsheet,” due to the user requesting climate patterns in Kentucky, rather than worldwide.

GMAgent 102 may next assemble a second prompt that includes the command generated based on the first prompt (e.g., “Write code to inspect file(s)” in FIG. 2). In the weather spreadsheet working example, GMAgent 102 may assemble the second prompt to include the command, “Write code to extract the first ten rows from the Kentucky weather spreadsheet.” The second prompt may also include data indicative of, for instance, the identities of the selected external data source(s) 105, the user's original natural language request if applicable, and so forth.

GMAgent 102 may then process the second prompt using one or more of the machine learning and/or generative model(s) 104 to generate first source code that is executable to inspect the files. In the weather spreadsheet working example, the generated source code may be executable to extract the first ten rows of data from the Kentucky weather spreadsheet. GMAgent 102 may then cause the first source code to be executed, e.g., in execution environment 112, to extract at least some data from one or more of the external data source(s) 105 and generate second output data. In FIG. 2, the first X lines extracted from each file may be returned. In the weather spreadsheet working example, the extracted data and second output data may include the first ten rows of the Kentucky weather spreadsheet.

Next, GMAgent 102 may assemble a third prompt that includes, for instance, the data returned from executing the first source code. In FIG. 2, this may include the first X lines from each file. In the weather spreadsheet working example, this may include the first ten rows from the Kentucky weather spreadsheet. GMAgent 102 may process the third prompt using machine learning and/or generative model(s) 104 to generate/predict next step(s). In FIG. 2, the next step is to “Write code to perform analytic task(s).” Notably, GMAgent 102/machine learning and/or generative model(s) 104 may predict multiple different candidate analytic tasks if the data extracted from inspecting the files lends itself to multiple different types of analysis/interpretation. In the weather spreadsheet working example, the next step may be to “Write code to perform one or more of the following candidate tasks: determine average rainfall by county, determine average temperature increase year by year and month by month, generate a line graph showing temperature trends in relation to latitude,” etc.

Whatever next steps are predicted based on the third prompt, data indicative of these next steps may be assembled, e.g., by GMAgent 102, into a fourth prompt. In some implementations, the fourth prompt may also be assembled with other data, such as characteristics of the external data source(s) 105, prior user inputs/queries/requests, and so forth. As shown by the dashed arrows, in some implementations, meanwhile, the user may be solicited to select from multiple different candidate analytic tasks, where applicable. The user may select which candidate analytic task they wish to perform, and that selected task may be incorporated into the fourth prompt. This may occur where, for instance, the user's query is relatively vague and/or ambiguous, and/or when the data is amenable to multiple different types of analytic tasks.

GMAgent 102 may process the fourth prompt using machine learning and/or generative model(s) 104 to generate source code to perform the selected task(s) (or all candidate tasks if the user makes no selection or is not solicited to make a selection). This source code to perform the selected tasks may be executed in execution environment 112 to generate analytic output 114 from the executed code. This analytic output may include, for instance, solutions to the analytic tasks. In the weather spreadsheet working example, the analytic output may include, for instance, determined average rainfall by county in Kentucky, determined average temperature increase year by year and month by month, a generated line graph (e.g., rendered based on an underlying markup file) showing temperature trends in relation to latitude, and so forth.

In some implementations, knowledge system 100 may be configured to iteratively predict increasingly refined next steps and/or source code generated based on next steps, particularly if analytic output generated during a particular iteration fails to adequately satisfy a user's original request. In FIG. 2, for instance, and as indicated by the dashed arrow(s), in some cases, the analytic output may be provided to user device 124, e.g., for rendition to user 122. This may provide user 122 with an opportunity to issue a follow up query or request that, for instance, critiques the analytic task or offers guidance as to how the analytic task can be performed differently to return more useful information.

In some implementations in which the analytic output takes the form of a markup language file that is operable to render an interactive visualization on client device 124, user 122 may be able to interact with the interactive visualization using client device 124 to, for instance, zoom in, select a portion of the interactive visualization and issue a request, such as “make this portion of the pie chart green,” “add a trend line to this scatter plot,” and so forth. This may result in a subsequent prompt being assembled that, when processed by GMAgent 102 using machine learning and/or generative model(s) 104, results in an update markup language file being generated. The updated markup language file may, when rendered, reflect the user's requested change.

Referring back to FIG. 2, the analytic output may be assembled by GMAgent 102 into a fifth prompt, e.g., in response to a follow up query/request from the user or automatically. The fifth prompt may include other data as well, such as a command to evaluate the analytic output for compliance with the original user query (or any user query issued subsequently), attribute(s) of the external data source(s) 105, the user quer (ies) issued during the multi-turn dialog, and so forth.

GMAgent 102 may then process the fifth prompt using machine learning and/or generative model(s) 104 to generate output indicative of whether the analytic output satisfies user quer (ies). In FIG. 2, for instance, the analytic output apparently did not satisfy the user query, because the next step is “write updated code.” In a real world example, this next step command would likely contain more detail, such as an indication that one or more characteristics of the analytic output signal are unsatisfactory.

Suppose the user issues a request (at the first instance or as a follow up) to “remove outliers from the data.” Suppose further that the external data source in question originally included 4,000 data points, and 2,500 of those data points were removed (and thus excluded from analytic output). In such a scenario, when machine learning and/or generative model(s) 104 are used by GMAgent 102 to process the fifth input prompt, which includes the command “remove outliers from the data” along with a significantly reduced dataset of 1,500 data points, machine learning and/or generative model(s) 104 may be prone to generate output such as “write code that removes fewer outliers,” or something to that effect. To achieve such a result, machine learning and/or generative model(s) 104 may have been previously trained/fine-tuned on training example dialogs in which requests to remove outliers from data (whether in external data sources or provided as part of a prompt) resulted in the data being reduced so dramatically that users explicitly requested new code to remove fewer outliers.

Referring back to FIG. 2, GMAgent 102 may then assemble a sixth prompt. The sixth prompt may include data indicative of the command to write updated code (e.g., “write code that removes fewer outliers”). In some implementations, the sixth prompt may include other data as well, such as data indicative of the source code generated based on the fourth prompt, any user queries issued during the current multi-turn dialog, attributes of the external data source(s) 105, etc.

GMAgent 102 may then process the sixth prompt using machine learning and/or generative model(s) 104 to generate output data that includes source code that has been updated/refined in accordance with the output (e.g., next step) generated based on the fifth prompt. As indicated by the dashed arrow in FIG. 2, in some implementations, the updated source code may be provided to client device 124, e.g., to be rendered for review/approval by user 122. This may be another opportunity for user 122 to issue a follow up query/request that can be used to guide future iterations of the process.

This updated source code may then be executed in execution environment 112 to generate updated analytic output. In some implementations, the updated analytic output may be assembled by GMAgent 102 into a seventh prompt. The seventh prompt may include other data as well, including but not limited to: a command to evaluate the update analytic output for compliance with the original user query (or any user query issued subsequently), attribute(s) of the external data source(s) 105, the user quer (ies) issued during the multi-turn dialog, and so forth.

GMAgent 102 may then process the seventh prompt using machine learning and/or generative model(s) 104 to generate/predict output data that indicates whether the updated analytic output satisfies quer (ies) issued by the user. Similar to the fifth prompt, the seventh prompt may cause generation/prediction of output data that indicates whether the updated analytic output satisfies prior user quer (ies). In FIG. 2, for instance, the output generated by GMAgent 102 based on the seventh prompt indicates that the analytic output is satisfactory. Consequently, the updated analytic output is provided for rendition on user device 124.

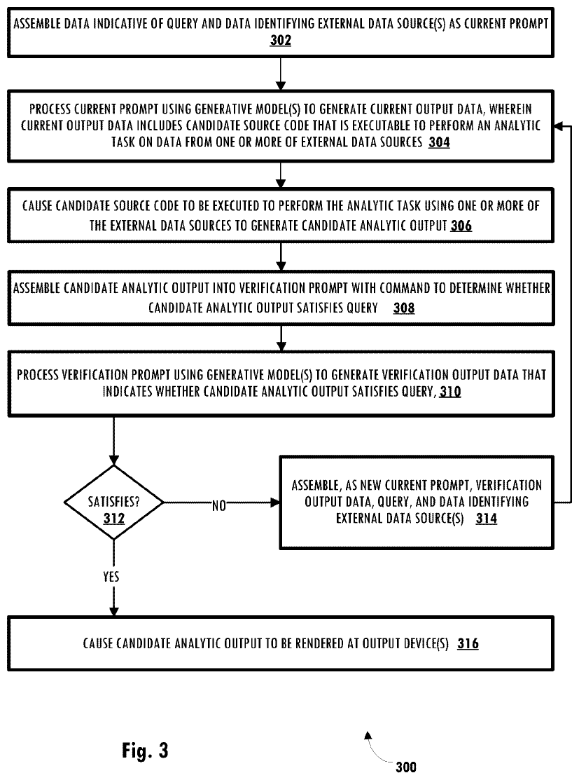

Referring now to FIG. 3, an example method 300 is depicted for carrying out an iterative, multi-turn dialog with GMAgent 102 that enables user 122 to leverage GMAgent 102 as a de facto data analyst. For convenience, the operations of the flowchart are described with reference to a system that performs the operations—in many cases the operations will be performed by GMAgent 102. This system may include various components of various computer systems, including those depicted in FIGS. 1-2. Moreover, while operations of method 300 are shown in a particular order, this is not meant to be limiting. One or more operations may be reordered, omitted or added.

At block 302, the system may assemble data indicative of a query and data identifying one or more external data source(s) (e.g., 105) into what will be referred to as a “current” prompt. For example, user 122 may operate client device 124 to issue a natural language request such as “remove outliers from this data,” “show me weather trends in Kentucky,” “give me a visualization of the asset breakdown in each division,” etc. Likewise, user 122 may operate client device 124 to identify one or more external data source(s) 105, such as tabular data (e.g., spreadsheets, CSV/TSV files, database tables and/or views, etc.), documents, videos, images, etc., e.g., by explicitly identifying them in the natural language request and/or by other means. For example, user 122 may operate a file system explorer to identify paths to files and/or upload files to a designated storage location that is accessible to GMAgent 102 and/or execution environment 112 of knowledge system 100.

At block 304, the system may process the first prompt using one or more machine learning and/or generative models (e.g., 104) to generate what will be referred to herein as “current” output data. The current output data may include, for instance, candidate source code that is executable to perform an analytic task on data from one or more of the external data source(s). In some implementations, there may be multiple instances of candidate source code generated, each corresponding to a different candidate analytic task. While not depicted in FIG. 3, in some implementations, user 122 may be provided with an opportunity to select from these candidate analytic tasks/candidate instances of source code.

At block 306, the system may cause the candidate source code to be executed, e.g., in execution environment 112, to perform the analytic task using one or more of the external data sources and generate analytic output (e.g., 114). Analytic output 114 may take various forms depending on the nature of the current source code. For example, analytic output 114 may include numeric data, textual data such as natural language, markup language or page description language that describes raw content and includes instructions for rendering it (e.g., JSON, Postscript), and so forth.

At block 308, the system may assemble analytic output 114 into a “verification” prompt with a command to determine whether analytic output 114 satisfies the current query. At block 310, the system may process the verification prompt using one or more of the machine learning and/or generative model(s) 104 to generate verification output data that indicates whether analytic output 114 satisfies the current query.

If the answer at block 312 is “no”, then method 300 may proceed to block 314. At block 314, the system assembles, as a new current prompt, one or more of: the verification output data, the current query, data identifying external data source(s), attributes of the identified external data source(s), etc. Method 300 may then proceed back to block 304, and blocks 304-312 may be repeated until the answer at block 312 is “yes” (i.e., the current candidate analytic output satisfies the query). At that point, at block 316, the system may cause the current candidate analytic output to be rendered at one or more output devices of client device 124.

While not shown in FIG. 3, user 122 may have opportunities to influence the multi-turn dialog by providing additional requests/feedback. For example, between blocks 306 and 308, the system may cause a prompt to be presented to user 122 at client device 124 that presents the current candidate analytic output and seeks feedback/approval. User 122 may provide feedback that can then be used to guide subsequent operations of method 300. In some implementations, the feedback provided by user 122 may be encoded into an embedding that is then combined (e.g., added, averaged, concatenated, etc.) with embedding(s) generated from the user's original query and/or any follow up queries/feedback provided by user 122 during the multi-turn dialog. This aggregated embedding may be incorporated into subsequent prompts to further guide and/or condition application of machine learning and/or generative model(s) 104.

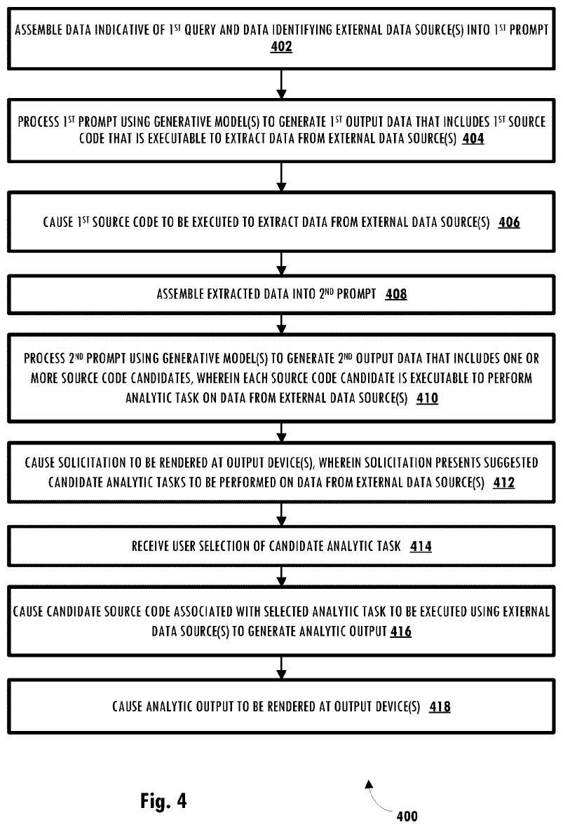

Referring now to FIG. 4, an example method 400 of practicing selected aspects of the present disclosure is described. For convenience, the operations of the flowchart are described with reference to a system that performs the operations. This system may include various components of various computer systems, including those depicted in FIGS. 1-2. Moreover, while operations of method 400 are shown in a particular order, this is not meant to be limiting. One or more operations may be reordered, omitted or added, e.g., in general or depending on the circumstances.

At block 402, the system may assemble data indicative of a first query and data identifying one or more external data source(s) into a first prompt. The first query may be explicitly provided by the user or implicitly provided. For example, if a user simply identifies and/or uploads external data source(s) 105, an implicit query may be something like “generate source code to inspect these files to determine what can be done next.”

At block 404, the system, e.g., by way of GMAgent 102, may process the first prompt using one or more machine learning and/or generative model(s) 104 to generate first output data. In various implementations, the first output data may include first source code that is executable to inspect the external data sources, e.g., by extracting at least some data from one or more of the external data sources. For example, if the user uploads a spreadsheet, the first source code may be executable to extract the first ten rows' worth of data. At block 406, the system may cause the first source code to be executed, e.g., in execution environment 112, to extract at least some data from one or more of the external data sources.

At block 408, the system may assemble the extracted data into a second prompt, e.g., along with the user's query, data identifying and/or attribute(s) of the external data source(s) 105, etc. At block 410, the system may process the second prompt using one or more of the generative models 104 to generate second output data. The second output data may include, for instance, one or more instances source code candidate that are executable to perform one or more candidate analytic tasks on data from one or more of the external data source(s) 105.

In some instances where multiple different candidate analytic tasks (and corresponding source code candidates) are predicted as next steps, user 122 may be presented (e.g., rendered on a screen or output at a speaker of client device 124) with a solicitation that allows the user to select one or more candidate analytic tasks to be performed. For instance, in FIG. 4, at block 412, the system may cause a solicitation to be rendered at output device(s). The solicitation may present suggested candidate analytic tasks to be performed on data from the identified external data source(s) 105. At block 414, the system may receive a user selection of one or more of the candidate analytic tasks to be performed.

At block 416, the system, e.g., by way of GMAgent 102, may cause the candidate source code associated with the selected analytic task to be executed, e.g., in execution environment 112, to perform the analytic task using one or more of the external data source(s) 105 and generate analytic output (e.g., 114). In various implementations, at block 418, the system may cause the analytic output to be presented as output at one or more output devices.

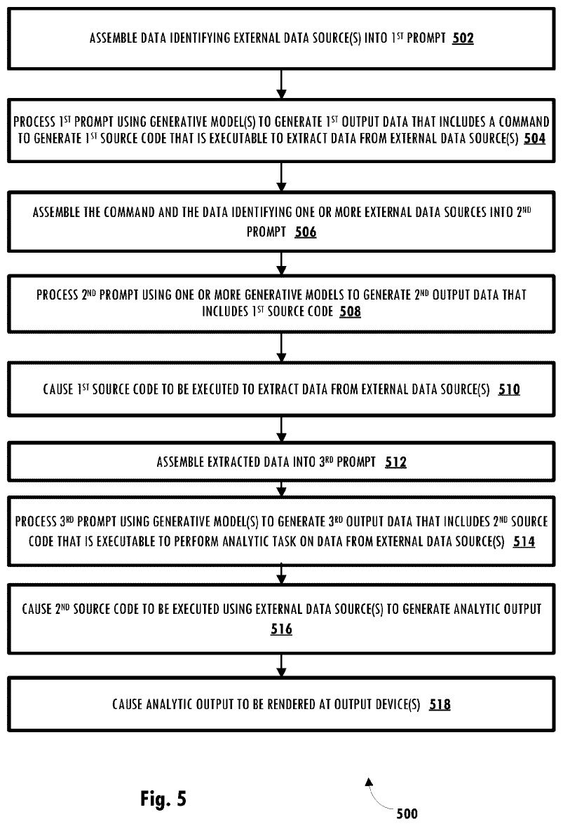

Referring now to FIG. 5, an example method 500 of practicing selected aspects of the present disclosure is described. For convenience, the operations of the flowchart are described with reference to a system that performs the operations. This system may include various components of various computer systems, including those depicted in FIGS. 1-2. Moreover, while operations of method 500 are shown in a particular order, this is not meant to be limiting. One or more operations may be reordered, omitted or added, e.g., in general or depending on the circumstances. Many of these operations are similar to those described previously.

At block 502, the system may assemble data identifying one or more external data source(s) 105 into a first prompt. At block 504, the system may process the first prompt using one or more machine learning and/or generative model(s) 104 to generate first output data. Unlike in FIG. 4, in FIG. 5, the first output data may include a command to generate first source code that is executable to extract at least some data from one or more of the external data source(s). An example of this was seen in FIG. 2 where the first prompt yielded the command, “Write code to inspect files.”

At block 506, the system may assemble the command and the data identifying one or more external data source(s) into a second prompt. At block 508, the system, e.g., by way of GMAgent 102, may process the second prompt using one or more machine learning and/or generative model(s) 104 to generate second output data. The second output data may include the first source code, which as noted above is executable to extract at least some data from one or more of the external data source(s). At block 510, the system may cause the first source code to be executed, e.g., in execution environment 112, to extract data from one or more of the external data sources.

At block 512, the system may assemble the extracted data into a third prompt, e.g., along with other data such as the query from the user, identifies of and/or attributes of the external data source(s) 105, etc. At block 514, the system may process the third prompt using one or more of the machine learning and/or generative model(s) 104 to generate third output data. The third output data may include, for instance, second source code that is executable to perform an analytic task on data from one or more of the external data source(s).

At block 516, the system may cause the second source code to be executed, e.g., in execution environment 112, to perform the analytic task using one or more of the external data source(s) to generate analytic output 114. At block 518, the system may cause the analytic output to be presented as output at one or more output devices of user device 124.

FIG. 6 is a block diagram of an example computer system 610. Computer system 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computer system 610. Network interface subsystem 616 provides an interface to outside networks and is coupled to corresponding interface devices in other computer systems.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computer system 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 610 to the user or to another machine or computer system.

Storage subsystem 624 stores programming and data constructs that provide the functionality of some or all of the modules described herein. For example, the storage subsystem 624 may include the logic to perform selected aspects of methods 300-500, and/or to implement one or more aspects of the various components depicted in FIGS. 1 and/or 2. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a CD-ROM drive, an optical drive, or removable media cartridges. Modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computer system 610 communicate with each other as intended. Although bus subsystem 612 is shown schematically as a single bus, alternative implementations of the bus subsystem may use multiple buses.

Computer system 610 can be of varying types including a workstation, server, computing cluster, blade server, server farm, smart phone, smart watch, smart glasses, set top box, tablet computer, laptop, or any other data processing system or computing device. Due to the ever-changing nature of computers and networks, the description of computer system 610 depicted in FIG. 6 is intended only as a specific example for purposes of illustrating some implementations. Many other configurations of computer system 610 are possible having more or fewer components than the computer system depicted in FIG. 6.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors and comprising:
assembling data indicative of a first query and data identifying one or more external data sources into a first prompt;
processing the first prompt using one or more generative models to generate first output data, wherein the first output data includes first source code that is executable to extract at least some data from one or more of the external data sources;
causing the first source code to be executed to extract at least some data from one or more of the external data sources;
assembling the extracted data into a second prompt;
processing the second prompt using one or more of the generative models to generate second output data that includes second source code, wherein the second source code is executable to perform an analytic task on data from one or more of the external data sources; and
causing the second source code to be executed to perform the analytic task using one or more of the external data sources and generate analytic output.

2. The method of claim 1, further comprising causing the analytic output to be presented as output at one or more output devices.

3. The method of claim 1, further comprising causing solicitation to be presented at one or more of the output devices, wherein the solicitation presents one or more suggested candidate analytic tasks to be performed on data from one or more of the external data sources, wherein the one or more suggested candidate analytic tasks includes the analytic task that is performed by causing the second source code to be executed.

4. The method of claim 1, wherein causing the first source code to be executed results in a subset of data being extracted from one or more of the external data sources.

5. The method of claim 4, wherein one or more of the external data sources comprises tabular data, and causing the first source code to be executed results in data from a selected number of rows and/or columns of the tabular data being extracted.

6. The method of claim 5, wherein the number of rows and/or columns is selected based on a total number of rows and/or columns in the tabular data.

7. The method of claim 1, wherein the analytic output is operable to render an interactive visualization associated with performance of the analytic task.

8. The method of claim 7, wherein the analytic output comprises markup language that is operable to render a chart or graphic visualizing one or more aspects of the analytic output or analytic task.

9. The method of claim 8, further comprising:
receiving an indication of user interaction with a portion of the chart or graphic; and
altering a portion of the markup language that corresponds to the interacted-with portion of the chart or graphic.

10. The method of claim 9, further comprising processing a second query, wherein the portion of the markup language is altered based on the second query.

11. The method of claim 10, further comprising:
generating a second prompt that includes data indicative of the second query and the portion of the markup language that corresponds to the interacted-with portion of the chart or graphic; and
processing the second prompt using one or more of the generative models to generate fifth output indicative of updated markup language that is operable to render an updated chart or graphic.

12. The method of claim 1, wherein one or more of the external data sources comprises an uploaded file.

13. The method of claim 1, wherein the second source code is executable to perform the analytic task on in-place data within one or more of the external data sources.

14. The method of claim 1, further comprising, prior to assembling the first prompt:
assembling data identifying the one or more external data sources into a preliminary prompt;
processing the preliminary prompt using one or more of the generative models to generate preliminary output, wherein the preliminary output includes a command to generate the first source code.

15. The method of claim 1, further comprising:
assembling the analytic output into a third prompt with a command to determine whether the analytic output satisfies the first query; and
processing the third prompt using one or more of the generative models to generate third output data that indicates the analytic output fails to satisfy the first query.

16. The method of claim 15, wherein the third output data comprises a command to generate third source code that comprises an updated version of the second source code.

17. The method of claim 15, further comprising:
assembling the third output data into a fourth prompt;
processing the fourth prompt using one or more of the generative models to generate fourth output data that includes the third source code, wherein the third source code comprises an updated version of the second source code that is executable to perform the analytic task on data from one or more of the external data sources.

18. A method implemented using one or more processors and comprising:
assembling data identifying one or more external data sources into a first prompt;
processing the first prompt using one or more generative models to generate first output data, wherein the first output data includes a command to generate first source code that is executable to extract at least some data from one or more of the external data sources;
assembling the command and the data identifying one or more external data sources into a second prompt;
processing the second prompt using one or more generative models to generate second output data, wherein the second output data includes the first source code that is executable to extract at least some data from one or more of the external data sources;
causing the first source code to be executed to extract data from one or more of the external data sources;
assembling the extracted data into a third prompt;
processing the third prompt using one or more of the generative models to generate third output data that includes second source code, wherein the second source code is executable to perform an analytic task on data from one or more of the external data sources;
causing the second source code to be executed to perform the analytic task using one or more of the external data sources to generate analytic output; and
causing the analytic output to be presented as output at one or more output devices.

19. A method implemented using one or more processors and comprising:
assembling data indicative of a first query and data identifying one or more external data sources into a first prompt;
processing the first prompt using one or more generative models to generate first output data, wherein the first output data includes first source code that is executable to perform an analytic task on data from one or more of the external data sources;
causing the first source code to be executed to perform the analytic task using one or more of the external data sources and generate analytic output;
assembling the analytic output into a second prompt with a command to determine whether the analytic output satisfies the first query; and
processing the second prompt using one or more of the generative models to generate second output data that indicates whether the analytic output satisfies the first query.

20. The method of claim 19, wherein the second output data comprises a command to generate second source code that comprises an updated version of the first source code.
